(19) United States
(12) Patent Application Publication
(10) Pub. No.: US 2026/0336248 A1
(43) Pub. Date: Oct. 29, 2026

(54) ROUNDED CORNER POSITIONING AND CUTTING DEVICE AND METHOD FOR COMPOSITE FILMS

(71) Applicant: Hangzhou Sotry Automatic Control Tech Co.,Ltd, Hangzhou (CN)

(72) Inventors: Juncheng Cai, Hangzhou (CN); Hongbiao Fu, Hangzhou (CN); Feng Huang, Hangzhou (CN); Xintian Liang, Hangzhou (CN); Yongbin Cai, Hangzhou (CN); Yiqing Zhang, Hangzhou (CN); Shuqi Fu, Hangzhou (CN)

(73) Assignee: Hangzhou Sotry Automatic Control Tech Co.,Ltd, Hangzhou (CN)

(21) Appl. No.: 19/577,325

(22) Filed: Mar. 24, 2026

(30) Foreign Application Priority Data
Apr. 23, 2025 (CN) 202510513942.8

(51) Int. Cl. B31B 70/00; B31B 70/14; B31B 70/18; B31B 155/00

(52) U.S. Cl. CPC B31B 70/006; B31B 70/148; B31B 70/18; B31B 2155/00

(57) ABSTRACT

The invention relates to the technical field of bag making machine control and, in particular, to a rounded corner positioning and cutting device and method for composite films. The device includes: a frame main body, a traction driver and a control center. A cutter assembly and a traction assembly are arranged on the frame main body; a camera is arranged on a feeding side of the cutter assembly. During the process of the control center sending the traction pulses to the traction driver, when receiving a termination instruction, the control center generates an error adjustment instruction on the basis of a first number of traction pulses sent during the traction process and an original image collected by the camera during the traction process, so as to control the cutter assembly to perform position adjustment and composite film cutting.

### CROSS-REFERENCE TO RELATED APPLICATION

This application claims the priority benefit of China application serial no. 202510513942.8, filed on Apr. 23, 2025. The entirety of the above-mentioned patent application is hereby incorporated by reference herein and made a part of this specification.

### TECHNICAL FIELD

The present invention relates to the technical field of bag making machine control and, in particular, to a rounded corner positioning and cutting device and method for composite films.

### BACKGROUND

A composite film bag making machine generally forms packaging bags by means of hot pressing with a longitudinal heat-sealing knife and a transverse heat-sealing knife, followed by cutting with a cutting tool. Due to the aforesaid processing procedure, the four corners of the finished packaging bags are strictly right angles. If the material is rigid, the four corners will be sharp, which may pose a potential safety hazard. Therefore, a die-cutting device or an on-line rounded corner forming device is subsequently used on the bag making machine to remove the sharp corners on all sides.

However, most of the conventional rounded corner cutting methods are based on feedbacks, where a logic controller calculates the output of a driver to obtain corresponding feedback pulses, and accurate positioning can only be performed after a stable In-Position (INP) signal is sent by a servo motor. On this basis, the triggering of camera photographing is realized by the logic controller receiving the number of pulses fed back from a servo driver to generate a camera trigger signal.

The aforesaid feedback-based positioning method and camera triggering method require a certain response time, which may introduce a certain delay. Such delay is particularly noticeable in high-speed production lines to cause errors, resulting in a reduction in production efficiency and waste of materials.

### SUMMARY

### 1. Technical problems to be solved

In view of the above shortcomings and deficiencies of the prior art, the present invention provides a rounded corner positioning and cutting device and method for composite films, which solves the technical problem that the feedback-based response method has a certain time delay, which in turn leads to a reduction in production efficiency and waste of materials.

### 2. Technical solutions

To achieve the above objective, the technical solutions mainly adopted by the present invention are as follows:

In the first aspect, an embodiment of the present invention provides a rounded corner positioning and cutting device for composite films, including: a frame main body, a traction driver and a control center; a cutter assembly for cutting a composite film and a traction assembly for pulling the composite film on a frame are arranged on the frame main body;

a camera is arranged on a feeding side of the cutter assembly, and the camera is configured to photograph the composite film in a preset area during a traction process;

both the camera and the traction assembly are electrically connected to the traction driver, and both the traction driver and the cutter assembly are electrically connected to the control center;

when receiving a traction instruction, the control center sends traction pulses to the traction driver in real time, so as to control the traction driver to drive the traction assembly to pull the composite film from the feeding side to a discharging side of the frame main body;

during the process of the control center sending the traction pulses to the traction driver, when receiving a termination instruction, the control center generates an error adjustment instruction on the basis of a first number of traction pulses sent during the traction process and an original image collected by the camera during the traction process, so as to control the cutter assembly to perform position adjustment and composite film cutting in response to the error adjustment instruction;

the original image refers to an image collected by the camera which is triggered for photographing when a traction sensor determines, on the basis of a second number of traction pulses received during the traction process, that a current traction length reaches a preset collection length.

Optionally, the cutter assembly includes a cutter, a cutter rest moving device, a cutter rest positioning motor and a cutter motor;

both the cutter and the camera are arranged on the cutter rest moving device, and a photographing center of the camera is located on a feeding side of a cutter edge of the cutter;

the cutter is electrically connected to the control center by means of the cutter motor; the cutter rest moving device is electrically connected to the control center by means of the cutter rest positioning motor;

when receiving the termination instruction, the control center generates the error adjustment instruction on the basis of the first number of traction pulses sent during the traction process and the original image collected by the camera during the traction process, so as to control, by means of the cutter rest positioning motor, the cutter rest moving device to perform position adjustment on the cutter, and control, by means of the cutter motor, the cutter to perform composite film cutting after the position adjustment.

In the second aspect, an embodiment of the present invention provides a rounded corner positioning and cutting method for composite films, which is implemented based on the rounded corner positioning and cutting device for composite films described above. The method includes:

S11. when the control center receives a traction instruction, sending traction pulses to the traction driver in real time, wherein the traction pulses are used to control the traction driver to drive the traction assembly to pull the composite film to move;

S12. recording, by the traction driver, the second number of received traction pulses in real time, and detecting in real time whether the current traction length reaches the preset collection length according to the second number;

if yes, sending, by the traction driver, a photographing instruction to the camera to trigger the camera to perform photographing,

wherein the photographing instruction is used to control the camera to collect an original image of the preset area and send the image to the control center; the original image includes a punched rhombic circular hole pre-formed on the composite film;

S13. inputting, by the control center, the original image into a preset image error detection model to obtain a corresponding image error, wherein the image error detection model is configured to fit a distance between the punched rhombic circular hole and a preset center point position of the camera, so as to obtain a corresponding image error; and

S14. when the control center receives a stop instruction, obtaining a corresponding error adjustment instruction from the first number of traction pulses sent currently, the image error and a preset standard bag length, so as to control the cutter assembly to perform position adjustment and composite film cutting in response to the error adjustment instruction.

Optionally, the image error detection model being configured to fit the distance between the punched rhombic circular hole and the preset center point position of the camera, so as to obtain the corresponding image error includes:
performing preprocessing on the received original image, wherein the preprocessing includes grayscale processing and noise removal;
extracting edge data of the punched rhombic circular hole in the original image by means of a preset edge detection algorithm, and fitting the center position of the punched rhombic circular hole based on the edge data; and
obtaining the corresponding image error from the center position of the punched rhombic circular hole and the preset center point position of the camera, wherein the image error refers to the distance between the center position of the punched rhombic circular hole and the center point position of the camera.

Optionally, the composite film is a composite film on which punched rhombic circular holes are formed via a punching process and which is subjected to longitudinal cutting;
accordingly, the image error detection model extracting the edge data of the punched rhombic circular hole in the original image by means of the preset edge detection algorithm, and fitting the center position of the punched rhombic circular hole based on the edge data includes:
extracting the edge data of the punched rhombic circular hole in the original image by means of the preset edge detection algorithm, wherein the edge data includes the coordinates of any point on the edge of the punched rhombic circular hole;
establishing, with respect to a preset X-axis, a preset number of detection lines perpendicular to the X-axis, wherein each detection line intersects the punched rhombic circular hole at two points, and the X-axis is a coordinate axis perpendicular to a longitudinal cutting direction;
obtaining, from the edge data of the punched rhombic circular hole, the intersection coordinate data of the two intersection points corresponding to each detection line;
fitting center point position data corresponding to each detection line on the basis of the intersection coordinate data of the two intersection points corresponding to each detection line;
fitting a center line corresponding to the punched rhombic circular hole on the basis of the center point position data corresponding to all the detection lines; and
obtaining a corresponding image error from the center line corresponding to the punched rhombic circular hole and the preset center point position of the camera, wherein the image error refers to the distance between the center line of the punched rhombic circular hole and the center point position of the camera.

Optionally, the image error detection model is further configured to:
before extracting the edge data of the punched rhombic circular hole, extract any corner of the punched rhombic circular hole in the preprocessed original image by means of a preset target detection algorithm, wherein the corner is the corner of the rhombic punched circular hole that is not intersected by the cutting line formed by the longitudinal cutting.

Optionally, said step S14 includes:
when the control center receives the stop instruction, obtaining a corresponding actual bag length from the first number and a preset traction distance of each traction pulse;
obtaining a corresponding bag length error from the actual bag length and the preset standard bag length;
obtaining a corresponding actual error from the bag length error and the image error; and
generating a corresponding error adjustment instruction on the basis of the actual error, so as to control the cutter assembly to perform position adjustment and composite film cutting in response to the error adjustment instruction.

Optionally, said step S12 includes:
recording, by the traction driver, the second number of received traction pulses in real time, and detecting the current traction length in real time on the basis of the second number and the preset traction distance of each traction pulse; and
determining, by the traction driver, in real time whether the current traction length reaches the preset collection length on the basis of preset configuration parameters of a BLOCK function block;
if yes, sending, by the traction driver, the photographing instruction to the camera,
wherein the configuration parameters of the BLOCK function block include input/output selection settings, position comparison pulse settings and position comparison output condition settings.

Optionally, the control center includes an industrial personal computer and a logic controller, wherein the traction driver and the cutter assembly are both electrically connected to the logic controller, and the camera and the logic controller are both electrically connected to the industrial personal computer;
accordingly, the photographing instruction is used to control the camera to collect the original image of the preset area and send the image to the industrial personal computer;
accordingly, said step S11 includes:
when the logic controller receives the traction instruction, sending traction pulses to the traction driver in real time;
information transmission between the logic controller and the traction driver is realized via a MODBUS communication protocol;
said step S13 includes:
inputting, by the industrial personal computer, the original image into the preset image error detection model to obtain a corresponding image error and sending the image error to the logic controller;
said step S14 includes:
when the logic controller receives the stop instruction, obtaining a corresponding error adjustment instruction from the first number of traction pulses sent currently, the image error and the preset standard bag length, so as to control the cutter assembly to perform position adjustment and composite film cutting in response to the error adjustment instruction.

Optionally, the device further includes a photoelectric sensor; the photoelectric sensor is arranged on the discharging side of the cutter assembly and is electrically connected to the control center;
accordingly, said step S14 further includes:
detecting, by the photoelectric sensor, a photoelectric signal of a target area in real time to determine whether the composite film is pulled to a target position; and
when it is determined that the composite film reaches the target position, sending the stop instruction to the control center.

### 3. Beneficial effects

The beneficial effects of the present invention are as follows: According to the rounded corner positioning and cutting device for composite films provided in the present invention, the photographing of the camera is triggered after the traction driver performs a position comparison, and the current actual bag length is derived from the first number of traction pulses sent by a logic controller. Compared with the prior art, the device avoids time delay, shortens the time consumed in the error calculation process, and increases the operating speed of the whole machine, thereby improving production efficiency and reducing the waste of materials.

### BRIEF DESCRIPTION OF THE DRAWINGS

FIG. 1 is a schematic plan view of a rounded corner positioning and cutting device for composite films provided in an embodiment of the present invention.

FIG. 2 is a flowchart of a rounded corner positioning and cutting method for composite films provided in an embodiment of the present invention.

FIG. 3 is a schematic diagram of an image processing process of an image error detection model provided in an embodiment of the present invention.

### REFERENCE NUMERALS

1: traction assembly; 2: camera; 3: cutter assembly; 21: light source; 22: fine adjustment handle; 31: cutter rest positioning motor.

### DESCRIPTION OF THE EMBODIMENTS

To better explain the present invention for ease of understanding, a detailed description thereof is provided below by way of specific embodiments in conjunction with the accompanying drawings.

According to the rounded corner positioning and cutting device for composite films provided in the embodiments of the present invention, the photographing of a camera 2 is triggered after the traction driver performs a position comparison, and the current actual bag length is derived from the first number of traction pulses sent by a logic controller. Compared with the prior art, the device avoids time delay, shortens the time consumed in the error calculation process, and increases the operating speed of the entire device, thereby improving production efficiency and reducing the waste of materials.

In order to better understand the above-described technical solution, exemplary embodiments of the present invention will be described in more detail below with reference to the accompanying drawings. Although exemplary embodiments of the present invention are shown in the drawings, it should be understood that the present invention may be implemented in various forms and should not be limited by the embodiments set forth herein. On the contrary, these embodiments are provided for a clearer and more thorough understanding of the present invention and to fully convey the scope of the present invention to those skilled in the art.

### Embodiment 1

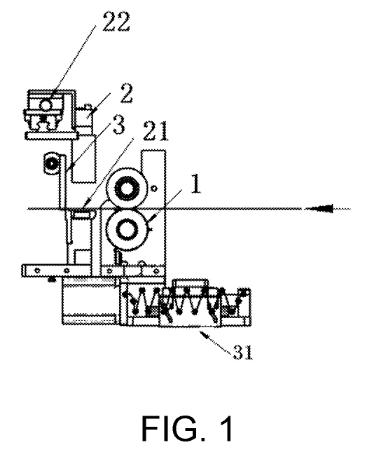

This embodiment provides a rounded corner positioning and cutting device for composite films, which, as shown in FIG. 1, includes a frame main body, a traction driver and a control center; a cutter assembly 3 for cutting a composite film and a traction assembly 1 for pulling the composite film on the frame are arranged on the frame main body.

A camera 2 is arranged on a feeding side of the cutter assembly 3, and the camera 2 is configured to photograph the composite film in a preset area during the traction process.

Both the camera 2 and the traction assembly 1 are electrically connected to the traction driver, and both the traction driver and the cutter assembly 3 are electrically connected to the control center.

When receiving a traction instruction, the control center sends traction pulses to the traction driver in real time, so as to control the traction driver to drive the traction assembly 1 to pull the composite film from the feeding side to a discharging side of the frame main body.

During the process of the control center sending the traction pulses to the traction driver, when receiving a termination instruction, the control center generates an error adjustment instruction on the basis of a first number of traction pulses sent during the traction process and an original image collected by the camera 2 during the traction process, so as to control the cutter assembly 3 to perform position adjustment and composite film cutting in response to the error adjustment instruction.

The original image refers to an image collected by the camera 2 which is triggered for photographing when a traction sensor determines, on the basis of a second number of traction pulses received during the traction process, that a current traction length reaches a preset collection length.

Further, the cutter assembly includes a cutter, a cutter rest moving device, a cutter rest positioning motor 31 and a cutter motor.

Both the cutter and the camera are arranged on the cutter rest moving device, and a photographing center of the camera is located on a feeding side of a cutter edge of the cutter.

The cutter is electrically connected to the control center by means of the cutter motor; the cutter rest moving device is electrically connected to the control center by means of the cutter rest positioning motor 31.

When receiving the termination instruction, the control center generates the error adjustment instruction on the basis of the first number of traction pulses sent during the traction process and the original image collected by the camera during the traction process, so as to control, by means of the cutter rest positioning motor 31, the cutter rest moving device to perform position adjustment on the cutter, and control, by means of the cutter motor, the cutter to perform composite film cutting after the position adjustment.

According to the rounded corner positioning and cutting device for composite films provided in this embodiment, the photographing of the camera 2 is triggered after the traction driver performs a position comparison, and the current actual bag length is derived from the first number of traction pulses sent by a logic controller. Compared with the prior art, the device avoids time delay, shortens the time consumed in the error calculation process, and increases the operating speed of the whole machine, thereby improving production efficiency and reducing the waste of materials.

### Embodiment 2

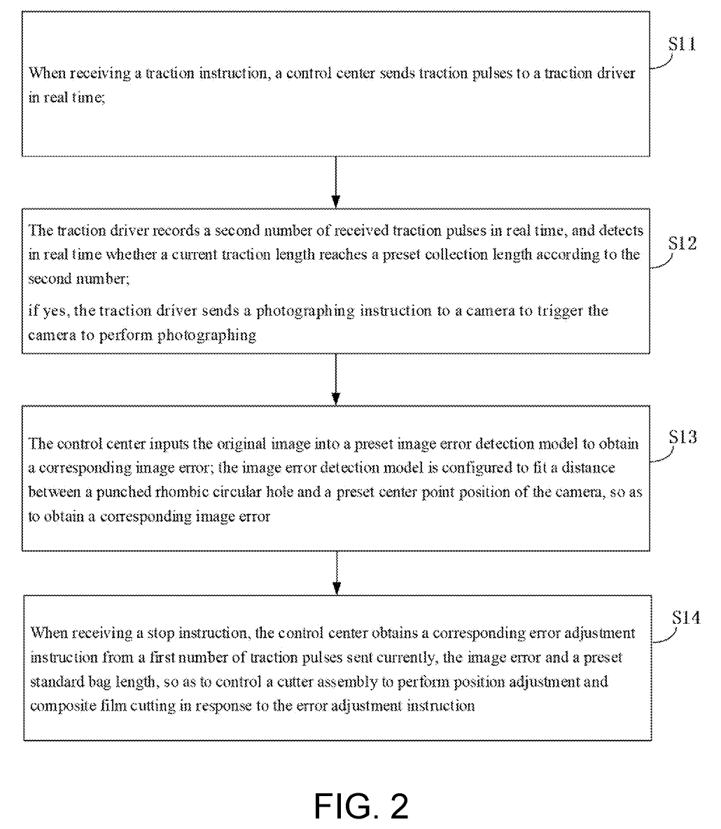

This embodiment provides a rounded corner positioning and cutting method for composite films, which, as shown in FIG. 2, is implemented based on the rounded corner positioning and cutting device for composite films provided in Embodiment 1. The method includes:

S11. when the control center receives a traction instruction, sending traction pulses to the traction driver in real time, wherein the traction pulses are used to control the traction driver to drive the traction assembly to pull the composite film to move;

S12. recording, by the traction driver, the second number of received traction pulses in real time, and detecting in real time whether a current traction length reaches the preset collection length according to the second number;
if yes, sending, by the traction driver, a photographing instruction to the camera 2 to trigger the camera 2 to perform photographing,
wherein the photographing instruction is used to control the camera 2 to collect an original image of a preset area and send the image to the control center; the original image includes a punched rhombic circular hole pre-formed on the composite film;

S13. inputting, by the control center, the original image into a preset image error detection model to obtain a corresponding image error, wherein the image error detection model is configured to fit a distance between the punched rhombic circular hole and a preset center point position of the camera 2, so as to obtain a corresponding image error; and

S14. when the control center receives a stop instruction, obtaining a corresponding error adjustment instruction from the first number of traction pulses sent currently, the image error and a preset standard bag length, so as to control the cutter assembly 3 to perform position adjustment and composite film cutting in response to the error adjustment instruction.

Further, the image error detection model being configured to fit the distance between the punched rhombic circular hole and the preset center point position of the camera 2, so as to obtain the corresponding image error includes:
performing preprocessing on the received original image, wherein the preprocessing includes grayscale processing and noise removal;
extracting edge data of the punched rhombic circular hole in the original image by means of a preset edge detection algorithm, and fitting the center position of the punched rhombic circular hole based on the edge data; and
obtaining the corresponding image error from the center position of the punched rhombic circular hole and the preset center point position of the camera 2, wherein the image error refers to the distance between the center position of the punched rhombic circular hole and the center point position of the camera 2.

The composite film is a composite film on which punched rhombic circular holes are formed via a punching process and which is subjected to longitudinal cutting.
accordingly, the image error detection model extracting the edge data of the punched rhombic circular hole in the original image by means of the preset edge detection algorithm, and fitting the center position of the punched rhombic circular hole based on the edge data includes:
extracting the edge data of the punched rhombic circular hole in the original image by means of the preset edge detection algorithm, wherein the edge data includes the coordinates of any point on the edge of the punched rhombic circular hole;
establishing, with respect to a preset X-axis, a preset number of detection lines perpendicular to the X-axis, wherein each detection line intersects the punched rhombic circular hole at two points, and the X-axis is a coordinate axis perpendicular to a longitudinal cutting direction;
obtaining, from the edge data of the punched rhombic circular hole, the intersection coordinate data of the two intersection points corresponding to each detection line;
fitting center point position data corresponding to each detection line on the basis of the intersection coordinate data of the two intersection points corresponding to each detection line;
fitting a center line corresponding to the punched rhombic circular hole on the basis of the center point position data corresponding to all the detection lines; and
obtaining a corresponding image error from the center line corresponding to the punched rhombic circular hole and the preset center point position of the camera 2, wherein the image error refers to the distance between the center line of the punched rhombic circular hole and the center point position of the camera 2.

Further, the image error detection model is further configured to:
before extracting the edge data of the punched rhombic circular hole, extract any corner of the punched rhombic circular hole in the preprocessed original image by means of a preset target detection algorithm, wherein the corner refers to the corner of the rhombic punched circular hole that is not intersected by the cutting line formed by the longitudinal cutting.

Further, said step S14 includes:
when the control center receives the stop instruction, obtaining a corresponding actual bag length from the first number and a preset traction distance of each traction pulse;
obtaining a corresponding bag length error from the actual bag length and the preset standard bag length;
obtaining a corresponding actual error from the bag length error and the image error; and
generating a corresponding error adjustment instruction on the basis of the actual error, so as to control the cutter assembly 3 to perform position adjustment and composite film cutting in response to the error adjustment instruction.

Said step S12 includes:
recording, by the traction driver, the second number of received traction pulses in real time, and detecting the current traction length in real time on the basis of the second number and the preset traction distance of each traction pulse; and
determining, by the traction driver, in real time whether the current traction length reaches the preset collection length on the basis of preset configuration parameters of a BLOCK function block;
if yes, sending, by the traction driver, a photographing instruction to the camera 2,
wherein the configuration parameters of the BLOCK function block include input/output selection settings, position comparison pulse settings and position comparison output condition settings.

According to the rounded corner positioning and cutting device for composite films provided in this embodiment, the photographing of the camera 2 is triggered after the traction driver performs a position comparison, and the current actual bag length is derived from the first number of traction pulses sent by a logic controller. Compared with the prior art, the method avoids time delay, shortens the time consumed in the error calculation process, and increases the operating speed of the whole machine, thereby improving production efficiency and reducing the waste of materials.

### Embodiment 3

This embodiment provides an online rounded corner positioning and cutting method for a composite film bag making machine, implemented on the basis of a bag making machine. On the mechanism of a conventional bag making machine, components such as a camera 2, a light source 21, a cutter rest moving device, a cutter rest positioning motor 31 and a cutter motor are added between a traction rubber roller (traction assembly 1) and a cutter (equivalent to the cutter assembly 3 including a cutter, a cutter rest moving device, a cutter motor and a cutter rest positioning motor 31; the cutter rest positioning motor 31 driving, by means of the cutter rest moving device, the cutter to perform position adjustment; and the cutter motor driving the cutter to perform cutting). The camera 2 is arranged on a cutter rest of the cutter, the distance between the center point of the camera 2 and the cutting edge of the cutter is adjustable; the light source 21 is mounted under a composite film and close to the inner side of the cutter, and emits upward light with adjustable brightness. The cutter rest positioning motor 31 has a structure composed of a linear guide rail and a lead screw, ensuring that the movement accuracy of the cutter rest moving device driven by the lead screw is within ±0.02 mm.

As shown in FIG. 1, the direction indicated by the horizontal arrow refers to the traction direction of the composite film (i.e., the direction from a feed inlet to a discharge outlet). The composite film is pulled to the cutter by the traction rubber roller; the light source 21 is arranged between the cutter and the traction rubber roller, and the camera 2 is arranged directly above the light source 21. The camera 2 is arranged on the cutter assembly 3 by means of a fine adjustment handle 22, and can be adjusted in the longitudinal and transverse directions of the horizontal plane under the driving of the fine adjustment handle 22.

Before being pulled to the traction rubber roller, rhombic circular holes are stamped on the composite film, and a cutting tool is mounted transversely to cut the film longitudinally; a traction servo motor (traction assembly 1) drives the composite film with the stamped rhombic circular holes to move toward the cutter assembly 3. During the traction movement of the servo motor, the control center continuously sends traction pulses to a servo motor driver (traction driver); meanwhile, the interior of the servo motor driver calculates the current traction length in real time according to the second number of received traction pulses on its own. Assume that the preset standard bag length of the current composite film is L, and the distance from the center point of the camera 2 to the projection of the cutter in the horizontal direction is H. During movement, when the servo motor driver calculates that the current traction length reaches L-H, the servo motor driver directly gives a photographing signal to trigger the camera 2 to photograph and capture a real-time image. The length and position comparison function of the servo motor driver employs the BLOCK function block of the driver. For this function block, it is required to set servo parameters including strobe input (STB) settings, input/output selection settings, position comparison output pulse width settings, position setting unit selection, position comparison output condition settings, and to complete Block action editing concurrently. The setting and modification of the above servo parameters (BLOCK function block configuration parameters) are all completed by means of communication with the control center in the Modbus mode.

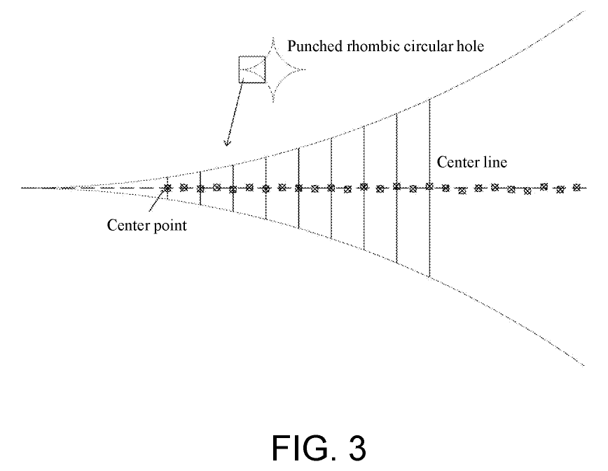

When the control center receives the original image captured by the camera 2, the processing procedure is as shown in FIG. 3. In general, only the data on the left side of the image is extracted to calculate the center line. The coordinate data (edge data) of pixel positions on upper and lower arcs can be determined by the edge detection algorithm. 30 equal devision points are selected in the X-axis direction on the left side of the image, and a straight line perpendicular to the X-axis (detection line) is drawn upward and downward from each of these 30 points respectively. Each detection line intersects the upper and lower arcs to obtain 60 intersection points. The coordinate data of the pixel positions of the upper and lower intersection points on the same detection line are summed and averaged to obtain 30 center points. With these 30 center points, a center line parallel to the X-axis can be fitted, and this center line is the center line of the stamped rhombic circular holes. The horizontal distance between this center line and the center of camera 2 is an image error corresponding to the original image, denoted as Tₑ.

On the other hand, in the process where the control center sends traction pulses to pull the composite film, the traction pulses are continuously sent. When the current length count of the composite film is within a specified range and a photoelectric sensor arranged at a designated position detects a valid photoelectric signal, the control center stops sending traction pulses, the traction assembly 1 stops traction, and the traction action is completed. In this case, the control center reads a first number of traction pulses sent currently, calculates a current actual bag length, and obtains an error Lₑ between the actual bag length and the preset standard bag length. Tₑ + Lₑ refers to the current total error, which is the position of the stamped rhombic circular hole relative to the cutter. After obtaining the total error, the control center drives, by means of the cutter rest positioning motor 31, the cutter rest moving device to move the cutter to the center position of the stamped rhombic circular hole and controls the cutter to move downward, thus completing an accurate cutting operation.

In practice, the cutter is fixed to linear guide rails on two sides of the frame main body by means of the cutter rest moving device, and a ball screw is driven by the cutter rest positioning motor 31 to move back and forth on the main body of the cutter rest. The camera 2 is fixed to the cutter rest moving device by means of the fine adjustment handle 22, and the distance between the center point of the camera 2 and the cutting edge of the cutter can be adjusted by means of the fine adjustment handle 22.

Signal acquisition of the camera 2, image algorithm calculation and image deviation calculation are realized by an industrial personal computer, while traction positioning, cutter cutting, temperature control and other parts are realized by a programmable logic controller (PLC), which also controls the cutter rest positioning motor 31.

Parameters of the traction servo motor and the traction driver, including input selection PR400, strobe input PR402, output selection PR411, output pulse width, position comparison output, are set by means of a touch screen. BLOCK action parameters, such as origin homing, origin homing method, homing direction, transition condition, are set.

After receiving a traction instruction, the PLC continuously sends traction pulses to the traction driver and concurrently counts the first number of traction pulses sent. A BLOCK function block in the traction driver performs comparison with the set data (H-L data) during counting; when the conditions are met, the traction driver triggers the camera 2 to photograph and capture the real-time original image of the stamped rhombic circular hole. After acquiring the image data, the industrial personal computer calculates deviation data between the center of the image and the center of camera 2 by means of the aforementioned algorithm, and the deviation data is denoted as image error Tₑ. The image error Tₑ is sent to the PLC in real time by means of serial communication.

The PLC continuously sends traction pulses during the traction movement. When photographing is completed and the traction is nearly finished, the PLC stops sending traction pulses once the photoelectric sensor detects a photoelectric signal, and the traction driver stops driving the traction action of the traction assembly 1. The PLC reads, in real time, the first number of traction pulses sent currently, and calculates the current actual bag length and the bag length error between the actual bag length and the preset standard bag length simultaneously. During this process, the PLC receives the image error sent from the industrial personal computer; the sum of the image error and the bag length error is the total error of the currently stamped rhombic circular hole, i.e., the position of the center of the stamped rhombic circular hole relative to the current cutter. The PLC controls the cutter to move to the center position of the currently stamped rhombic circular hole to perform cutting.

In this embodiment, the control over the bag making machine is realized by the PLC, while image photographing, image algorithm, error calculation and the like are all completed by the industrial personal computer. A liquid crystal touch screen is connected to the industrial personal computer via HDMI, the industrial personal computer is connected to the PLC by means of communication via a serial port, and the human-computer interaction of the PLC is transferred by means of the industrial personal computer. In this way, a control interface of the PLC and a rhombic circular hole cutting interface are displayed on the same liquid crystal display and support touch operation, which avoids the situation where a bag making machine control interface and a diamond-shaped hole cutting interface are distributed on different displays. Therefore, the operation becomes more convenient.

According to the online rounded corner positioning and cutting method for a composite film bag making machine provided in this embodiment, the photographing instruction for the camera 2 is directly sent to the camera 2 by the traction driver after position comparison. This design is more accurate and timely compared with the way that a PLC generates a trigger signal by calculating the number of pulses fed back by a servo driver. A current bag making length is obtained from the number of instruction pulses sent by the PLC; this design is more accurate and causes no time delay, in contrast to the conventional method where the PLC can only calculate the bag making length more accurately by counting the output feedback pulses of a traction driver after a servo motor outputs a stable in-place (INP) signal. In addition, the image center algorithm for the rhombic circular hole takes the coordinates of multiple points on the two arcs into account, which is more scientific than the method that only considers the vertex coordinates of the two arcs and eliminates the influence of external interference factors on the image of a single point. In summary, the method provided in this embodiment can obtain the center position of the stamped rhombic circular hole and the position of the cutter more accurately, shortens the time consumed in the error calculation process, and improve the operating speed of the whole machine.

It should be appreciated that the terms "first” and "second” are used for descriptive purposes only rather than being understood as indicating or implying relative importance or as implicitly indicating the quantity of technical features indicated. Therefore, the features defined as "first" and "second" may explicitly or implicitly include one or more of the features. As described herein, "a plurality of" means two or more, unless otherwise clearly and specifically defined.

As used herein, the terms such as "installed", "connected", "connected” and "fixed", should be understood in a broad sense, unless otherwise expressly specified and defined. For example, it may be a fixed connection, a detachable connection, or an integrated connection; it may be a mechanical connection or an electrical connection; it may be a direct connection or an indirect connection by means of an intermediate medium; it may be the internal connection of two elements or the interaction relationship between two elements. For those of ordinary skill in the art, the specific meanings of the above terms in the present invention can be understood according to specific circumstances.

As used herein, unless expressly specified and defined otherwise, when a first feature is referred to as being "on" or "under" a second feature, it may mean that the first and second features are in direct contact with each other, or that the first and second features are in indirect contact with each other by means of an intermediate medium. Moreover, when a first feature is referred to as being "above", "over" or "on" a second feature, it may mean that the first feature is directly or obliquely above the second feature, or merely indicates that the horizontal height of the first feature is higher than that of the second feature. When a first feature is referred to as being "below", "underneath" or "under" a second feature, it may mean that the first feature is directly or obliquely below the second feature, or merely indicates that the horizontal height of the first feature is lower than that of the second feature.

Reference in the description of the present invention to terms such as "an embodiment," "some embodiments," “embodiment," "example," "specific example" or "some examples" means that a particular feature, structure, material, or characteristic described in connection with the embodiment or example is included in at least one embodiment or example of the invention. As used herein, the schematic representations of the above terms do not necessarily refer to the same embodiment or example. Moreover, the specific features, structures, materials or characteristics described may be combined in any one or more embodiments or examples in a suitable manner. In addition, those skilled in the art may combine and integrate the different embodiments or examples described herein and the features thereof without conflicting with each other.

Although the embodiments of the present invention are shown and described above, it should be understood that the embodiments described above are illustrative only and shall not be construed as limiting the present invention. A person of ordinary skill in the art may make alterations, modifications, substitutions and variations to the above-described embodiments within the scope of the present invention.

What is claimed is:

1. A rounded corner positioning and cutting device for composite films, including: a frame main body, a traction driver and a control center; a cutter assembly for cutting a composite film and a traction assembly for pulling the composite film on a frame are arranged on the frame main body;
wherein a camera is arranged on a feeding side of the cutter assembly, and the camera is configured to photograph the composite film in a preset area during a traction process;
both the camera and the traction assembly are electrically connected to the traction driver, and both the traction driver and the cutter assembly are electrically connected to the control center;
when receiving a traction instruction, the control center sends traction pulses to the traction driver in real time, so as to control the traction driver to drive the traction assembly to pull the composite film from the feeding side to a discharging side of the frame main body;
during a process of the control center sending the traction pulses to the traction driver, when receiving a termination instruction, the control center generates an error adjustment instruction on a basis of a first number of the traction pulses sent during the traction process and an original image collected by the camera during the traction process, so as to control the cutter assembly to perform position adjustment and composite film cutting in response to the error adjustment instruction;
the original image refers to an image collected by the camera which is triggered for photographing when a traction sensor determines, on a basis of a second number of the traction pulses received during the traction process, that a current traction length reaches a preset collection length.

2. The rounded corner positioning and cutting device for composite films according to claim 1, wherein the cutter assembly includes a cutter, a cutter rest moving device, a cutter rest positioning motor and a cutter motor; both the cutter and the camera are arranged on the cutter rest moving device, and a photographing center of the camera is located on the feeding side of a cutter edge of the cutter;
wherein, the cutter is electrically connected to the control center by means of the cutter motor; the cutter rest moving device is electrically connected to the control center by means of the cutter rest positioning motor;
when receiving the termination instruction, the control center generates the error adjustment instruction on the basis of the first number of the traction pulses sent during the traction process and the original image collected by the camera during the traction process, so as to control, by means of the cutter rest positioning motor, the cutter rest moving device to perform the position adjustment on the cutter, and control, by means of the cutter motor, the cutter to perform the composite film cutting after the position adjustment.

3. A rounded corner positioning and cutting method based on the rounded corner positioning and cutting device for composite films according to claim 1, wherein the method includes:
3S11. when the control center receives the traction instruction, sending the traction pulses to the traction driver in real time; wherein the traction pulses are used to control the traction driver to drive the traction assembly to pull the composite film to move;
3S12. recording, by the traction driver, the second number of the received traction pulses in real time, and detecting in real time whether the current traction length reaches the preset collection length according to the second number;
if yes, sending, by the traction driver, a photographing instruction to the camera to trigger the camera to perform photographing;
wherein the photographing instruction is used to control the camera to collect the original image of the preset area and send the image to the control center; the original image includes a punched rhombic circular hole pre-formed on the composite film;
3S1. inputting, by the control center, the original image into a preset image error detection model to obtain a corresponding image error; the image error detection model is configured to fit a distance between the punched rhombic circular hole and a preset center point position of the camera, so as to obtain the corresponding image error; and
3S14. when the control center receives a stop instruction, obtaining the corresponding error adjustment instruction from the first number of the traction pulses sent currently, the image error and a preset standard bag length, so as to control the cutter assembly to perform the position adjustment and the composite film cutting in response to the error adjustment instruction.

4. The rounded corner positioning and cutting method according to claim 3, wherein the image error detection model being configured to fit the distance between the punched rhombic circular hole and the preset center point position of the camera, so as to obtain the corresponding image error includes:
performing preprocessing on the received original image; the preprocessing includes grayscale processing and noise removal;
extracting edge data of the punched rhombic circular hole in the original image by means of a preset edge detection algorithm, and fitting a center position of the punched rhombic circular hole based on the edge data; and
obtaining the corresponding image error from the center position of the punched rhombic circular hole and the preset center point position of the camera, wherein the image error refers to the distance between the center position of the punched rhombic circular hole and the center point position of the camera.

5. The rounded corner positioning and cutting method according to claim 4, wherein the composite film is a composite film on which punched rhombic circular holes are formed via a punching process and which is subjected to longitudinal cutting;
accordingly, the image error detection model extracting the edge data of the punched rhombic circular hole in the original image by means of the preset edge detection algorithm, and fitting the center position of the punched rhombic circular hole based on the edge data includes:
extracting the edge data of the punched rhombic circular hole in the original image by means of the preset edge detection algorithm; the edge data includes coordinates of any point on an edge of the punched rhombic circular hole;
establishing, with respect to a preset X-axis, a preset number of detection lines perpendicular to the X-axis, wherein each detection line intersects the punched rhombic circular hole at two points, and the X-axis is a coordinate axis perpendicular to a longitudinal cutting direction;
obtaining, from the edge data of the punched rhombic circular hole, intersection coordinate data of the two intersection points corresponding to each detection line;
fitting center point position data corresponding to each detection line on a basis of the intersection coordinate data of the two intersection points corresponding to each detection line;
fitting a center line corresponding to the punched rhombic circular hole on a basis of the center point position data corresponding to all the detection lines; and
obtaining the corresponding image error from the center line corresponding to the punched rhombic circular hole and the preset center point position of the camera, wherein the image error refers to the distance between the center line of the punched rhombic circular hole and the center point position of the camera.

6. The rounded corner positioning and cutting method according to claim 5, wherein the image error detection model is further configured to:
before extracting the edge data of the punched rhombic circular hole, extract any corner of the punched rhombic circular hole in the preprocessed original image by means of a preset target detection algorithm, wherein the corner is the corner of the rhombic punched circular hole that is not intersected by a cutting line formed by the longitudinal cutting.

7. The rounded corner positioning and cutting method according to claim 5, wherein said step S14 includes:
when the control center receives the stop instruction, obtaining a corresponding actual bag length from the first number and a preset traction distance of each traction pulse;
obtaining a corresponding bag length error from the actual bag length and the preset standard bag length;
obtaining a corresponding actual error from the bag length error and the image error; and
generating the corresponding error adjustment instruction on a basis of the actual error, so as to control the cutter assembly to perform the position adjustment and the composite film cutting in response to the error adjustment instruction.

8. The rounded corner positioning and cutting method according to claim 3, wherein said step S12 includes:
recording, by the traction driver, the second number of the received traction pulses in real time, and detecting the current traction length in real time on a basis of the second number and a preset traction distance of each traction pulse; and
determining, by the traction driver, in real time whether the current traction length reaches the preset collection length on a basis of preset configuration parameters of a BLOCK function block;
if yes, sending, by the traction driver, the photographing instruction to the camera;
the configuration parameters of the BLOCK function block include input/output selection settings, position comparison pulse settings and position comparison output condition settings.

9. The rounded corner positioning and cutting method according to claim 3, wherein the control center includes an industrial personal computer and a logic controller, wherein the traction driver and the cutter assembly are both electrically connected to the logic controller, and the camera and the logic controller are both electrically connected to the industrial personal computer;
accordingly, the photographing instruction is used to control the camera to collect the original image of the preset area and send the image to the industrial personal computer;
accordingly, said step S11 includes:
when the logic controller receives the traction instruction, sending the traction pulses to the traction driver in real time;
information transmission between the logic controller and the traction driver is realized via a MODBUS communication protocol;
said step S13 includes:
inputting, by the industrial personal computer, the original image into the preset image error detection model to obtain the corresponding image error and sending the image error to the logic controller;
said step S14 includes:
when the logic controller receives the stop instruction, obtaining the corresponding error adjustment instruction from the first number of the traction pulses sent currently, the image error and the preset standard bag length, so as to control the cutter assembly to perform the position adjustment and the composite film cutting in response to the error adjustment instruction.

10. The rounded corner positioning and cutting method according to claim 3, wherein the device further includes a photoelectric sensor; the photoelectric sensor is arranged on the discharging side of the cutter assembly and is electrically connected to the control center;
accordingly, said step S14 further includes:
detecting, by the photoelectric sensor, a photoelectric signal of a target area in real time to determine whether the composite film is pulled to a target position; and
when it is determined that the composite film reaches the target position, sending the stop instruction to the control center.
